(19) United States
(12) Patent Application Publication
(10) Pub. No.: US 2025/0069175 A1
(43) Pub. Date: Feb. 27, 2025

(54) SYSTEMS FOR RECOVERY OF STOLEN VEHICLES

(71) Applicant: FCA US LLC, Auburn Hills, MI (US)

(72) Inventors: Xin Feng, Troy, MI (US); Tingzheng Zhou, Rochester, MI (US)

(21) Appl. No.: 18/455,011

(22) Filed: Aug. 24, 2023

(51) Int. Cl. G06Q 50/26

(52) U.S. Cl. CPC G06Q 50/265

(57) ABSTRACT

In at least some implementations, a system for recovery of stolen vehicles includes a historical data source including historical information relating to locations of stolen vehicles, a geographic image source including ratings of different areas as a function of a likelihood of stolen vehicles being in each area and a processing and data system. The processing and data system is configured to: receive a location from where a vehicle was stolen and a time when the vehicle was stolen, use the location to identify an area surrounding the location in which the vehicle could have been taken, identify historical information and geographic information in the area surrounding the location and to analyze the historical information and geographic information to determine places within the area where the vehicle is most likely to be found after having been stolen.

### FIELD

The present disclosure relates to systems and methods for recovery of stolen vehicles.

### BACKGROUND

Once stolen, vehicles can be moved quickly and relatively far outside of the area from which they were stolen. Locating the vehicles can be difficult with a large potential area to be searched in which the vehicle could have been moved. Some services like OnStar or Lojack, rely upon GPS devices within a vehicle to track a stolen vehicle. However, many vehicle thieves know how to remove or disable such devices which can render the devices of little use in locating a stolen vehicle. Additionally, many vehicles do not have such devices installed.

### SUMMARY

In at least some implementations, a system for recovery of stolen vehicles includes a historical data source including historical information relating to locations of stolen vehicles, a geographic image source including ratings of different areas as a function of a likelihood of stolen vehicles being in each area and a processing and data system. The processing and data system is configured to: receive a location from where a vehicle was stolen and a time when the vehicle was stolen, use the location to identify an area surrounding the location in which the vehicle could have been taken, identify historical information and geographic information in the area surrounding the location and to analyze the historical information and geographic information to determine places within the area where the vehicle is most likely to be found after having been stolen.

In at least some implementations, the historical information includes locations at which previously stolen vehicles had been recovered.

In at least some implementations, the geographic data source includes aerial images of the area and wherein the ratings are based at least in part on the density of vehicles within portions of the area. In at least some implementations, the geographic data source includes data relating to the type of businesses within the area, and wherein the ratings are based at least in part on a category of one or more businesses within the area. In at least some implementations, the processing and data system includes a processor and memory arranged to perform an analysis of the aerial images and to assign the ratings. In at least some implementations, the processor and memory are arranged to identify vehicles within the aerial images. In at least some implementations, the geographic information includes data relating to the type of businesses within the area, and wherein the ratings are based at least in part on a category of one or more businesses within the area.

In at least some implementations, the processing and data system includes a processor and memory arranged to determine a size of the area surrounding the location based on the time since the vehicle was determined to have been stolen.

In at least some implementations, a method of providing information for the recovery of a stolen vehicle, includes determining a location from which a vehicle was reported to have been stolen, determining an area surrounding the location in which the vehicle is most likely to currently be, analyzing information relating to the area surrounding the location to determine the most likely locations for the vehicle, and providing the information to an entity seeking to find the vehicle.

In at least some implementations, the step of determining an area surrounding the location is accomplished as a function of the time since the vehicle was stolen.

In at least some implementations, the step of analyzing information is accomplished by a processor arranged to identify vehicles within aerial images of the area, and which also includes assigning a rating to portions of the area as a function of the number of vehicles in each portion.

In at least some implementations, the step of analyzing information is accomplished with a database that includes information about the type of businesses within the area, and which also includes assigning a rating to one or more businesses in the area wherein the ratings are based at least in part on a category of the one or more businesses within the area.

In at least some implementations, the step of analyzing information is accomplished with a database that includes historical information about the locations at which stolen vehicles previously were located within the area, and which also includes assigning a rating to portions of the area as a function of the number of stolen vehicles previously located in each portion.

In at least some implementations, the step of analyzing information is accomplished by: a) a processor arranged to identify vehicles within aerial images of the area; b) with information about the type of businesses within the area; and c) and with historical information about the locations at which stolen vehicles previously were located within the area, and which also includes assigning a rating to portions of the area as a function of the number of vehicles in each portion, the type of businesses within the area and the number of stolen vehicles previously located in each portion. In at least some implementations, the step of analyzing information is performed before a vehicle is determined to be stolen and the step of providing the information to an entity is performed after the vehicle is determined to be stolen and after the area is determined.

By using image recognition techniques, map-based data and historical information regarding stolen vehicles, the systems and methods can determine, for a given area surrounding a location from which a vehicle was stolen, the most likely places that the stolen vehicle will be taken to after being stolen. This information can be provided to a searcher to make the search more efficient and effective, with areas having a higher likelihood to include a stolen vehicle able to be searched sooner or over a greater time, and with less time spent in lower likelihood areas. The system may use machine learning techniques to adapt to new and updated information, so the system and methods can be adaptive to the latest trends and changes in information with a minimum amount of human interaction needed to make such system improvements.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a system for assisting in the recovery of stolen vehicles;

FIGS. 2A, 2B, 2C, 2D and 2E are images showing different geographic regions having varying features of interest and that may be analyzed by the system of FIG. 1;

FIGS. 3A and 3B illustrate plots of historical data on an aerial image and a map;

FIG. 4 is an isochrone map indicating the area in which a vehicle may have travelled in a given amount of time;

FIG. 5 is a map having an overlay that gives a visual display of the likelihood that a stolen vehicle is within a given portion of the geographic region shown in the map;

FIG. 6 shows a method for determining the most likely areas in which a stolen vehicle may be located; and

FIG. 7 shows a method for determining the most likely areas in which a stolen vehicle may be located with some parts of the method performed in parallel with other parts of the method.

### DETAILED DESCRIPTION

The drawings relate to systems and methods for determining areas in which a stolen vehicle is more likely to be found, and for assisting entities in finding a stolen vehicle. The systems and methods gather and analyze information pertaining to past occurrences and locations of stolen vehicles and geographic data including areas of vehicle density, and areas and businesses more likely to be associated with stolen vehicles. The information may be updated and the system may learn trends or changes regarding stolen vehicles within one or more geographic areas to provided improved information to entities seeking to find a stolen vehicle. Areas and businesses can be rated based on predetermined criteria to identify portions of an area to be searched that are the most likely areas in which stolen vehicles will end up or pass through. With the systems and methods, among other things, the time and geographic area needed for a search for a stolen vehicle can be reduced, and the success rate of finding stolen vehicles can be improved.

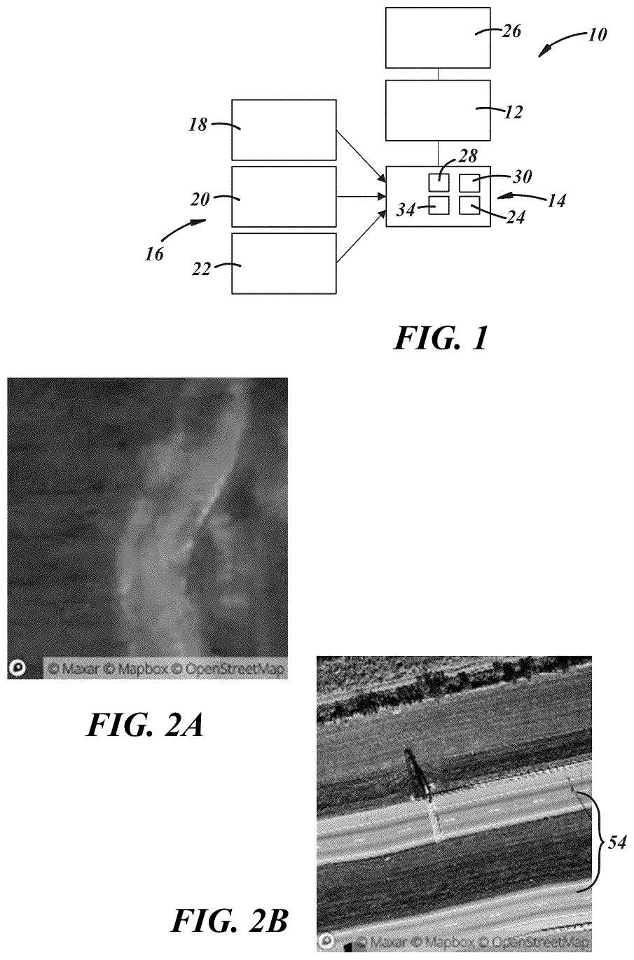

With reference to the schematic diagram in FIG. 1, there is shown an example of a stolen vehicle information system 10 that can determine areas in which stolen vehicles are more likely to be found based upon multiple information sources. System 10 may be a cloud-based system that includes a report portal 12 to receive reports that a vehicle has been stolen, a processing and data system 14 and information sources 16 (e.g. one or more databases) which may include a geography data source that may include one or both of a geographic image source 18, a map-based data source 20 and a historical data source 22. The system 10 may use and analyze information from the information sources 16 as well as a location from which the vehicle was believed to have been stolen, and provide a list of areas in which the stolen vehicle is most likely be to make the search for the stolen vehicle more efficient. System 10 may deliver hosted services via the internet and/or other communication networks and may be structured as a public, private or hybrid cloud, and may include appropriate communication devices 24 for receipt and/or transmission of information.

According to one non-limiting example, the stolen vehicle information system 10 is structured as a private cloud and generally includes a processing and data system 14 with reports of stolen vehicles being provided to the report portal 12 over a secure communications network 26. The communications network 26 may include a cellular-based network, a satellite-based network, a city-wide WiFi-based network, some other type of communications network and/or a combination thereof.

The processing and data system 14 may include any suitable combination of software and/or hardware resources typically found in a backend of a cloud-based system, as best illustrated in FIG. 1, and is generally responsible for receiving and analyzing historical information relating to previously stolen vehicles and geographic information from one or more sources. The processing and data system 14 may be managed or controlled by the vehicle manufacturer and may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the processing and data system 14). In one example, the processing and data system 14 has a number of backend resources including data storage systems 28, servers 30, communication systems 24, programs and algorithms run by one or more processors and memory 34, as well as other suitable backend resources. It should be appreciated that processing and data system 14 is not limited to any particular architecture, infrastructure or combination of elements, and that any suitable processing and data system arrangement may be employed.

The information sources 16 may include geographic data and historical data. In at least some implementations, the geography data may include aerial or other images of various geographic regions, and map data including information about business within various geographic regions. In at least some implementations, the historical information includes data regarding locations of previously stolen vehicles, or areas associated with previously stolen vehicles. The aerial or other images and map data may be from freely available satellite imagery or map sources, like Google Earth, Google Maps, Apple Maps, Mapbox, and the like. The images and map data may come from the same source, or different sources, as desired.

The processing and data system 14 may include one or more algorithms 34 that identify features of interest within geographic regions of the images for analysis by the system as set forth herein. Some examples of features of interest may include density of vehicles in an area, population density, business density and the like. The system 10 may analyze and rate different geography regions or areas based on predetermined criteria relating to at least some features of interest, where the criteria are intended to distinguish between areas in which stolen vehicles are more likely to be found and areas where stolen are less likely to be found. This data is referred to herein as image-based data.

The map data may include textual information, which may be in tabular form (e.g. tabular metadata from a mapping or navigation service) about, for example, the addresses and types of business in an area. The system 10 may analyze the map data and rate different geographic regions based on predetermined criteria relating to the map data, where the criteria are intended to distinguish between areas in which stolen vehicles are more likely to be found and areas where stolen are less likely to be found. In at least some implementations, the system 10 identifies one or more categories of businesses that are more often associated with stolen vehicles, such as private automotive repair facilities, part supply facilities (e.g. junk yards), used car sales lots, vehicle auction sites, towing companies, and the like.

The historical information regarding locations of stolen vehicles may be a private database with information gathered by the system 10 internally, may include external databases such as may be available from law enforcement agencies or other sources. The private database may track and be updated by information relating to stolen vehicles reported to the system to continually provide a greater volume of information in the private database. The system may receive periodically updated information from external databases and analyze the updated information so that the system remains up to date and accurate in view of the latest trends in movement of stolen vehicles. The historical information may include information about the location from where vehicles were stolen, the locations where stolen vehicles were later found, and the locations where vehicles traveled after being stolen. As to the latter, the vehicle GPS or other location device/service may be used to track the vehicle or to learn the vehicle's path(s) of travel after being stolen.

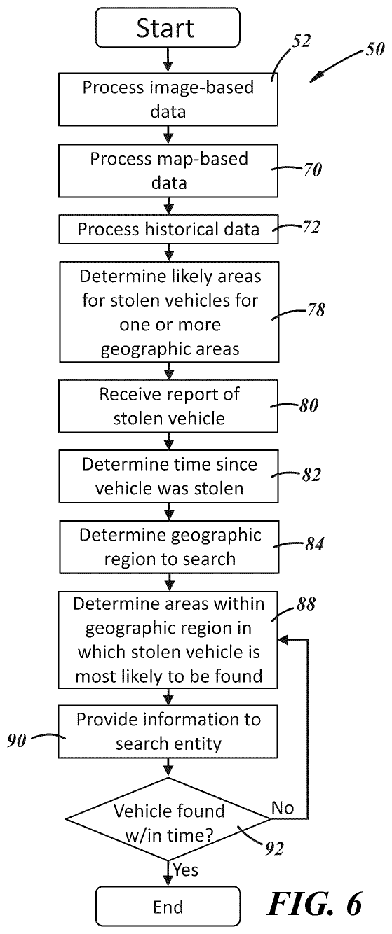

Turning now to FIG. 6, there is shown an example of a method 50 for determining areas in which a stolen vehicle is most likely to be found. The different steps of the method may be executed or carried out by any suitable combination of components, devices, computers, modules and/or systems of the processing and data system 14 (e.g. backend resources).

In step 52, the method obtains images and uses those images to provide image-based data for further evaluation. The exact manner in which step 52 obtains, pre-processes, and processes the images and/or provides the image-based data can vary depending on the particular implementation. In one non-limiting example, step 52 gathers or obtains raw images from one or more image sources, such as a satellite imaging service, and performs formatting tasks on the raw images in order to format them before they are analyzed by more sophisticated and complex image processing functions, like model training and inference functions. The formatting tasks may include filtering or removing certain image imperfections, tuning the brightness, correcting the color, resizing the images, changing the orientation, etc. Skilled artisans will appreciate that by performing pre-processing tasks on the images before further image processing takes place, computational resources may be reduced and/or image processing speeds may be enhanced, formatted, processed in some other way or raw, they are set for use by the system and method as set forth herein.

The image data is processed by the system to determine locations of any features of interest that have been determined to be relevant to the movement of stolen vehicles. Features of interest may be determined by image recognition technology and with programming designed to enable detection of the desired features. For example, heavily populated areas like cities sometimes have more incidents of stolen vehicles and more locations in which stolen vehicles are later found than less populated/rural areas. Areas with junk yards, used car sales lots, automotive repair centers or other areas with higher vehicle density, where vehicles are discernable from the image(s), can also be more likely to include or have stolen vehicles pass through (e.g. be located there at some point after being stolen). Further features of interest may be determined and the system arranged to determine such features from the images.

There are many potential image processing and other techniques that may be used to analyze the image data, including the use of various types of object detection and object recognition programs, algorithms and/or models. One suitable family of object detection techniques uses computer vision tasks and is called regions with convolutional neural networks (R-CNN). R-CNN utilizes deep learning approaches with two stages: a first stage identifies a subset of regions in an image that may include an object, and a second stage classifies the objects in each region. Skilled artisans will appreciate that there are myriad image processing and/or object detection techniques that may be used, such as fast R-CNN and faster R-CNN which are members of the R-CNN family of techniques, as well as others, like the you-only-look-once (YOLO) family of techniques.

The locations of the features of interest within an image, or a geographic area are stored, and may be analyzed to rank or rate the features of interest according to predetermined criteria. The rating may apply a first score to an area deemed more likely to include a stolen vehicle and a second score to an area deemed less likely to include a stolen vehicle. The first and second scores may be on a scale having a given number of increments, for example without limitation, a scale of 1 to 10. Of course, other numbers of increments may be used, as desired. A list or hierarchy or matrix of areas deemed most likely to include a stolen vehicle may be achieved by way of the image analysis and ratings.

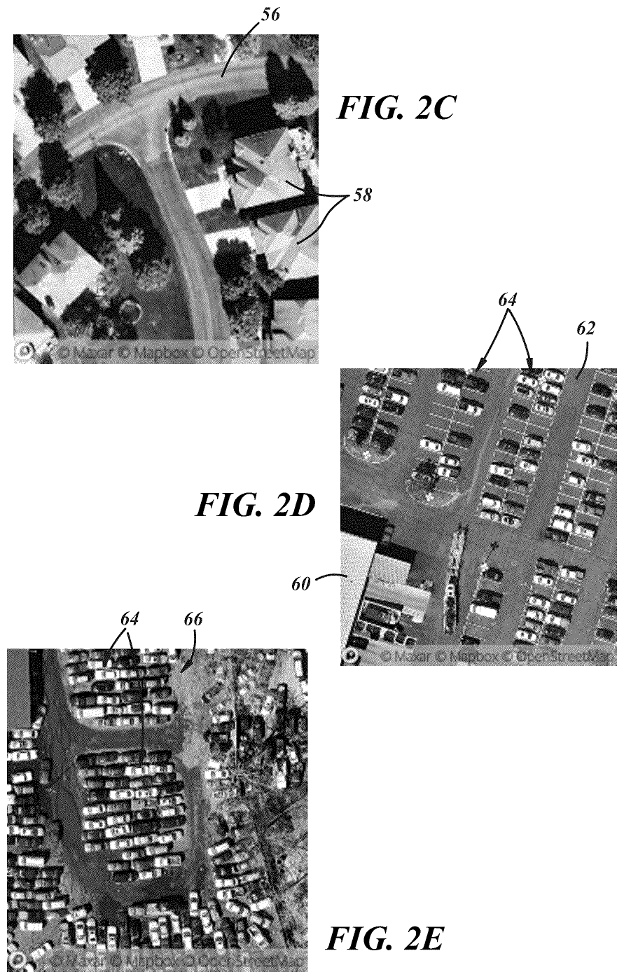

Examples of images are shown in FIGS. 2A-2E. In FIG. 2A, a rural area is captured in the image. This area has open land without businesses or buildings or roads or vehicles or other features of interest and may be given a low rating as stolen vehicles are not likely to be located here, in this example. FIG. 2B shows an image with a paved road 54 or highway without buildings or other features, and may be given a score higher than FIG. 2A but still low on the scale as there are no businesses or building to which a stolen vehicle is likely to be taken. FIG. 2C shows an image with roads 56 and houses 58, a busier area with more locations of interest than in FIGS. 2A and 2B, and this may be given an intermediate score. FIG. 2D shows part of a building 60 and a large parking lot 62, with lots of vehicles 64 parked in an orderly fashion such as is common in a parking lot of a shopping center or office building complex. This may be given a higher score than the images of FIGS. 2A-2C as the parking lot and business could be areas where a stolen vehicle is likely to be taken. Finally, FIG. 2E shows an area 66 of dense vehicle parking that denotes a junk yard or vehicle salvage yard. This may be determined based at least in part that the vehicles are parked too close together to be in a normal parking lot, which is common at such locations. The area shown in this image may be given a high rating as areas of mass vehicle storage like a junk yard or salvage yard are deemed likely spots for stolen vehicles, in this example.

Each image in FIGS. 2A-2E may be part of larger aerial images and the various areas of the larger aerial images may be broken down into the smaller images or tiles, each smaller image may be rated and then the combination of smaller images in a larger area may be given a rating or score that is a function of the ratings given to the smaller areas within the larger area. In this way, larger areas may be given ratings to help narrow down a broader search area, and the smaller areas are also rated and available for review on a more granular level to assist a search within the selected search area.

Next, in step 70, the map-based data may be obtained and analyzed. The map-based data may include textual information about features or points of interest. For example, the map-based data may include names and/or a description of various entities, public and private, in a geographic region. The geographic regions of map-based data may coincide with the regions included in the image data, or it may be different and correlated to other regions, as desired.

The map-based data may be analyzed to rank or rate the features of interest or geographic areas according to predetermined criteria. The rating may apply a first score to a location/entity/business deemed more likely to include a stolen vehicle and a second score to a location/entity/business deemed less likely to include a stolen vehicle. The first and second scores may be on a scale having a given number of increments, for example without limitation, a scale of 1 to 10. Of course, other numbers of increments may be used, as desired. The locations/entities/businesses in the map-based data may be grouped into categories based on the types of products or services provided, and the categories may be rated in a predetermined manner according to desired criteria. A list or hierarchy or matrix of locations/entities/businesses deemed most likely to include a stolen vehicle may be achieved by way of the image analysis and ratings. The scale or ratings for the map-based data may be the same as that used for the image data, as desired. In this way, a location/entity/business of a given rating may be deemed as likely to include or be associated with a stolen vehicle as an area given the same or a similar rating in the analysis of image data.

While individual businesses may be rated, the map-based data may also be analyzed on a larger scale with areas rated based on various criteria having to do with features within each area. For example, the number of certain businesses in an area may make that area more likely to include a stolen vehicle. Non-limiting examples include the number of each of the following or a combination of two or more and up to all of the following: junk yards, car repair shops, vehicle impound yards, towing companies, shopping malls, and retail stores (where shopping malls and retail stores provide groups of vehicles from which vehicles may be stolen, or stolen vehicles may be parked and abandoned). In this way the map-based data may be used to rate individual locations as well as larger areas within different geographic regions.

In step 72, historical data may be obtained and may be analyzed to rank or rate areas or locations/entities/businesses according to predetermined criteria. The historical data may include information about the locations of previously stolen and recovered vehicles, and this information may be provided from various sources including sources outside of the system 10, like law enforcement or insurance company records or databases, as well as an internal database of the system that is periodically updated with information about stolen vehicles.

The rating may apply a first score to an area or a location/entity/business deemed more likely to include a stolen vehicle and a second score to an area of a location/entity/business deemed less likely to include a stolen vehicle. The first and second scores may be on a scale having a given number of increments, for example without limitation, a scale of 1 to 10. Of course, other numbers of increments may be used, as desired. A list or hierarchy or matrix of areas deemed most likely to include a stolen vehicle may be achieved by way of the image analysis and ratings. The scale or ratings for the historical data may be the same as that used for the image data and/or map-based data, as desired. In this way, an area or a location/entity/business of a given rating may be deemed as likely to include or be associated with a stolen vehicle as an area given the same or a similar rating in the analysis of image data.

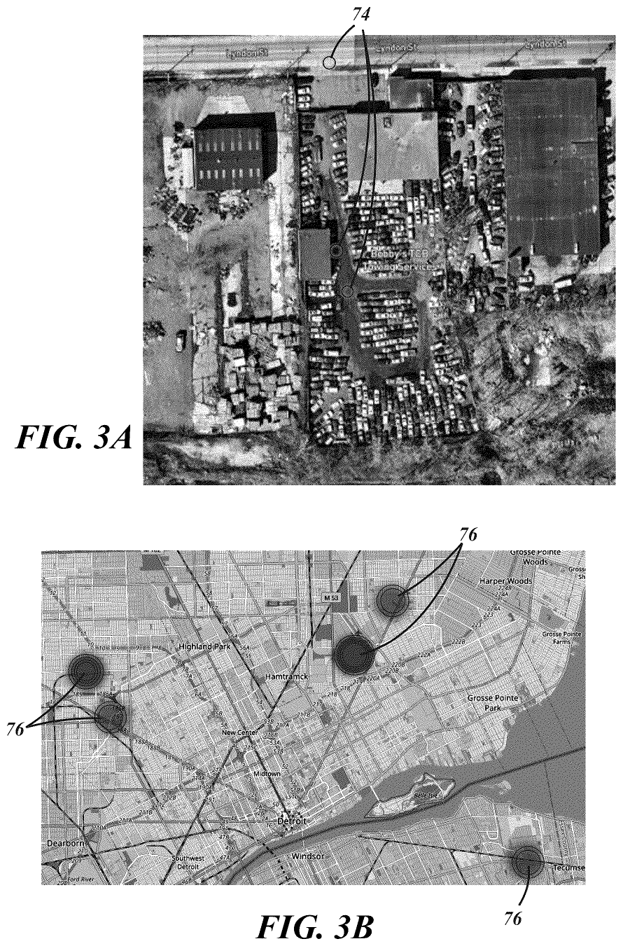

The historical data may include textual descriptions or coordinates of locations associated with previously stolen vehicles, a map plot of such information or both. FIG. 3A shows a satellite image with locations of previously stolen vehicles denoted by circles 74 on the image. FIG. 3B shows a map with a layer/overlay including larger circles 76 of different colors, where the circles could be of different size or color or transparency or clarity to denote different numbers of stolen vehicle incidents associated with those areas, or multiple areas of higher likelihood that are near each other and joined in a single, larger circle or other indicator. For example, a larger circle could be used to denote more stolen vehicle incidents in that area compared to an area having a smaller circle. Or, as another example, different colors may be used to denote levels of incidents, e.g., an area overlayed with a red circle indicates more stolen vehicles in that area compared to an area overlayed with a blue circle.

The analysis of the image data, map-based data and historical data may be combined to determine, in step 78, areas or locations of interest that are more likely to include stolen vehicles. The map-based data and historical data may be arranged geographically and matched with the image data, if desired. A combination of the ratings may be used to determine the most likely areas for a stolen vehicle to end up in or travel near/through. The combined ratings may be compared to a threshold or simply arranged in rank order. In at least some implementations, any analysis or part of the rating process that assigns a rating greater than a threshold (e.g. 7 or higher out of 10) may be determined to be an area of interest if a vehicle is stolen within a certain distance of that area of interest.

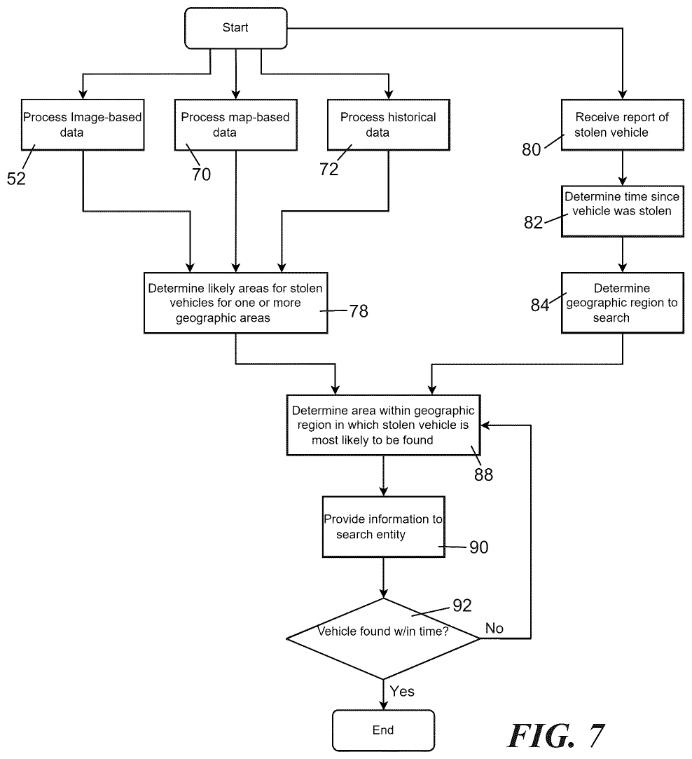

The analysis and ratings discussed above may be accomplished prior to, at the same time or after receipt of a report that a vehicle has been stolen, which occurs in step 80 in method 50, as shown by the alternate flowchart of FIG. 7. When the vehicle is reported stolen, and attempt may be made in step 82 to determine the time or a range of times in which the vehicle was stolen.

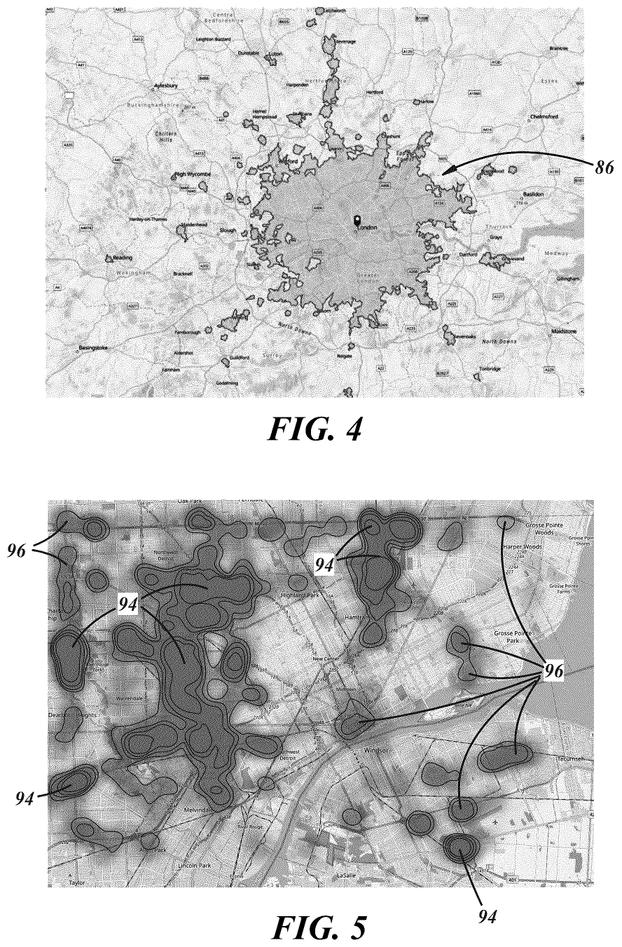

From that determination or otherwise, in step 84, a geographic radius or area to search may be determined. The area may be determined with use of an isochrone map, like that shown in FIG. 4, which depicts the area 86 accessible from a point within a certain period of time. This may take into account speed limits, traffic lights, traffic and the like, and may make the search area more accurate than simply using a radius and a corresponding circle from the point from which the vehicle was stolen. In FIG. 4 the areas that could be reached in the selected time threshold are shown in gray and are overlayed on a map display. The area to search may depend upon the time since the vehicle was stolen and an average or assumed maximum distance the vehicle may travel in the time since the vehicle was stolen. The area to search may be based upon the location of area deemed, from the analysis above, most likely to include a stolen car, or other factors, as desired.

Within an area to be searched, in step 88, the ratings may be checked to determine locations within the search area that are most likely to include a stolen vehicle, and in step 90, that information may be provided to the search entity (e.g. local law enforcement) to improve the efficiency and effectiveness of the search. Simply canvassing the entirety of an area to search can take a long time, and is costly and not efficient. Focusing the search to locations determined based on one or more of the image data, map-based data and historical data can improve the efficiency and effectiveness of the search, and reduce the time needed to locate a stolen vehicle.

In at least some implementations, if the search area was determined based upon time (e.g. time since the vehicle was stolen), then the method may set a time threshold and if the vehicle is not found within the time threshold, as checked in step 92, then the search area may be determined again and it may be expanded in view of the greater time since the vehicle as determined to have been stolen. This may continue until the vehicle is found or the search is ended for other reasons.

The information may be provided as part of a service offering from an entity, such as the vehicle manufacturer. The images, map and historical data for areas of coverage of the service offering may be reviewed on an ongoing basis to provide an up-to-date service that is ready to determine areas of highest likelihood for a stolen vehicle after a vehicle is reported stolen. The analysis may be done for a given search area after a vehicle is stolen and a search area is determined.

The analysis may yield a visual output, like a map having portions in different colors (e.g. a semi-transparent layer applied in different colors over a map display) according to the likelihood that a stolen vehicle will be in each portion of a search area. A representative map is shown in FIG. 5, in which areas of greatest likelihood 94 are presented in one color and areas of lesser likelihood 96 in a different color, with any number of colors/shades of colors being used to denote different ratings/likelihoods of a stolen vehicle being found in such areas. This may be a so-called “heat map” with areas having a higher number of incidents of stolen vehicle activity appearing to be “hotter” on the map than areas with a lower number of incidents, which appear “cooler”. In such an example, red, orange and similar colors may be used to denote hotter areas, while blue, green or no color depict cooler areas. In this regard, areas not highlighted are not necessarily no risk or not likely at all to contain a stolen vehicle, but fall below a threshold rating in the shown implementation and so are not colored at all or highlighted by a circle or other indicia/indicator.

With the systems and method described herein, the exact location of the vehicle is not needed and is assumed to not be known. Some services like OnStar or Lojack, rely upon GPS devices within a vehicle to track a stolen vehicle. However, many vehicle thieves know how to remove or disable such devices which can render them of little use. Additionally, many vehicles do not have such devices installed and so the systems and method set forth herein can be used to facilitate search and recovery of stolen vehicles.

The system may include machine learning techniques so that new image data, map-based data and historical data can automatically be analyzed and rated, and added to the information of the system. In this way, the system can learn areas of greater incidents of stolen vehicles and can update the ratings as well as the criteria used in the ratings of data, to improve the accuracy of the system over time, and as more data is included in the system.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A system for recovery of stolen vehicles, comprising:
a historical data source including historical information relating to locations of stolen vehicles;
a geographic image source including ratings of different areas as a function of a likelihood of stolen vehicles being in each area;
a processing and data system that is configured to: receive a location from where a vehicle was stolen and a time when the vehicle was stolen, use the location to identify an area surrounding the location in which the vehicle could have been taken, identify historical information and geographic information in the area surrounding the location and to analyze the historical information and geographic information to determine places within the area where the vehicle is most likely to be found after having been stolen.

2. The system of claim 1 wherein the historical information includes locations at which previously stolen vehicles had been recovered.

3. The system of claim 1 wherein the geographic data source includes aerial images of the area and wherein the ratings are based at least in part on the density of vehicles within portions of the area.

4. The system of claim 3 wherein the geographic data source includes data relating to the type of businesses within the area, and wherein the ratings are based at least in part on a category of one or more businesses within the area.

5. The system of claim 3 wherein the processing and data system includes a processor and memory arranged to perform an analysis of the aerial images and to assign the ratings.

6. The system of claim 5 wherein the processor and memory are arranged to identify vehicles within the aerial images.

7. The system of claim 6 wherein the geographic data source includes data relating to the type of businesses within the area, and wherein the ratings are based at least in part on a category of one or more businesses within the area.

8. The system of claim 1 wherein the processing and data system includes a processor and memory arranged to determine a size of the area surrounding the location based on the time since the vehicle was determined to have been stolen.

9. A method of providing information for the recovery of a stolen vehicle, including:
determining a location from which a vehicle was reported to have been stolen;
determining an area surrounding the location in which the vehicle is most likely to currently be;
analyzing information relating to the area surrounding the location to determine the most likely locations for the vehicle; and
providing the information to an entity seeking to find the vehicle.

10. The method of claim 9 wherein the step of determining an area surrounding the location is accomplished as a function of the time since the vehicle was stolen.

11. The method of claim 9 wherein the step of analyzing information is accomplished by a processor arranged to identify vehicles within aerial images of the area, and which also includes assigning a rating to portions of the area as a function of the number of vehicles in each portion.

12. The method of claim 9 wherein the step of analyzing information is accomplished with a database that includes information about the type of businesses within the area, and which also includes assigning a rating to one or more businesses in the area wherein the ratings are based at least in part on a category of the one or more businesses within the area.

13. The method of claim 9 wherein the step of analyzing information is accomplished with a data source that includes historical information about the locations at which stolen vehicles previously were located within the area, and which also includes assigning a rating to portions of the area as a function of the number of stolen vehicles previously located in each portion.

14. The method of claim 9 wherein the step of analyzing information is accomplished by: a) a processor arranged to identify vehicles within aerial images of the area; b) with information about the type of businesses within the area; and c) and with historical information about the locations at which stolen vehicles previously were located within the area, and which also includes assigning a rating to portions of the area as a function of the number of vehicles in each portion, the type of businesses within the area and the number of stolen vehicles previously located in each portion.

15. The method of claim 14 wherein the step of analyzing information is performed before a vehicle is determined to be stolen and the step of providing the information to an entity is performed after the vehicle is determined to be stolen and after the area is determined.
